(19) United States
(12) Patent Application Publication
(10) Pub. No.: US 2010/0290689 A1
(43) Pub. Date: Nov. 18, 2010

(54) DISCRIMINATING INFARCTS FROM ARTIFACTS IN MRI SCAN DATA

(76) Inventors: Varsha Gupta, Singapore (SG); Bhanu K.N. Prakash, Singapore (SG); Wieslaw Lucjan Nowinski, Singapore (SG)

Correspondence Address: DICKSTEIN SHAPIRO LLP, 1825 EYE STREET NW, Washington, DC, 20006-5403, US

(21) Appl. No.: 12/812,387

(22) PCT Filed: Jan. 6, 2009
(86) PCT No.: PCT/SG09/00009

§ 371 Date: Jul. 9, 2010

Related U.S. Application Data
(60) Provisional application No. 61/020,187, filed on Jan. 10, 2008.

(51) Int. Cl. G06K 9/00

(52) U.S. Cl. 382/131

(57) ABSTRACT

An algorithm is proposed to eliminate from MRI images pixels which have been incorrectly identified as corresponding to infarct material. A first technique is to eliminate identified regions which are determined to be similar to the region of the scan which corresponds to the identified region reflected in the mid-sagittal plane (MSP) of the brain. A second technique is to eliminate regions which are determined not to have corresponding identified regions in one or more of the other scans. The combination of two techniques enhances the confidence in the decision of whether a hyperintense region is an infarct or artifact.

### SUMMARY OF THE INVENTION

The present invention relates to methods of processing MRI (magnetic resonance imaging) scans, particularly DWI (diffusion-weighted images) MRI scans.

### BACKGROUND OF THE INVENTION

Generally, there are two types of errors [1] in any observation: systematic and random. Systematic errors tend to shift all measurements in a particular direction. Some of the main reasons of such errors are incorrect calibration of an instrument, improper use of the instrument, etc. Large systematic errors can be often be eliminated (e.g. by applying zero correction of the instrument or repeating the experiment), but small systematic errors will always be present since no instrument can ever be calibrated perfectly. This is the reason why several independent confirmations of experimental results should be performed, preferably using different techniques.

If an experiment is performed several times with all experimental conditions constant, the outcome is still different. These fluctuations in the outcome are called random errors (or statistical errors). The value of the outcome is taken as the mean of observations and the standard deviation is taken as the error on the mean. The standard deviation can sometimes be obtained by repeating the experiment, but in some practical situations it is impossible to repeat experiments. In these situations, the knowledge of the distribution of outcome is applied to predict statistical errors. The outcome usually follows certain known distributions depending on the nature of the experiment e.g. the Poisson distribution is a common outcome in experiments which include a count. For the Poisson distribution, standard deviation (σ) is related to mean (μ) as σ=\sqrt{μ} [1]. Because of the relationship between μ and σ, one is able to predict an error from the outcome of the experiment (where the outcome is a result of counts per unit time); for example, Ref. [2] used a Poisson distribution-based noise removal technique for nuclear medical imaging since such imaging involves a number of decays per unit time.

The process of MRI acquisition is very complicated (http://www.easymeasure.co.uk/principlesmri.aspx, http://www.sunnybrook.ca/research/groups/cardiac_mri/MR_background, accessed Oct. 23, 2007). MRI signal intensity has a complicated dependence on many parameters including the count of magnetically excited protons in the voxel during the image acquisition time. Since intensity is in part also related to the count of magnetically excited protons, the Poisson distribution is used to predict the distribution of intensity of each pixel. In the light of this assumption, an error on the pixel intensity can be predicted. Thus, the reported pixel value can be assumed to have error equal to \sqrt{p_{μ}} where p_{μ} is the mean pixel intensity of some hypothetical observations.

There are various kinds of acquisition artifacts associated with MRI scans (some are describe at http://www.mritutor.org/mritutor/artifact.htm, accessed Oct. 23, 2007) such as motion artifacts, aliasing artifacts, susceptibility artifacts etc. Some known methods to remove artifacts and reduce noise are as follows. Ref [3] presents a Wavelet-based Rician noise removal for MRI. Ref [4] describes an approach to noise filtering in multi-dimensional data using a partial volume data density model. Ref [5] suggests correcting bulk in-plane motion artifacts in MRI using a point spread function. A more elaborate list of these methods is included in (http://iris.usc.eduNision-Notes/bibliography/medical891.html, accessed Oct. 23, 2007).

Computer aided detection (CAD) plays a significant role in aiding accurate medical image interpretations in different areas [e.g. 6-10]. The present inventors have developed a suite of CAD systems for acute ischemic and hemorrhagic strokes [11-13]. One of key algorithms is segmentation of infarcts. Its accuracy depends on correct discrimination of infarct from artifacts. Accurate and rapid quantification of infarcts from DWI scans is critical in acute ischemic strokes. Acquisition artifacts lead to hyperintense regions in DWI MR scans resulting in false positives. Discriminating infarcts and artifacts helps to reduce infarct segmentation errors.

### SUMMARY OF THE INVENTION

The present invention relates to post-processing segmented MRI images to increase the accuracy of infarct delineation.

In general terms, the algorithm proposes that an MRI image of a brain, such as a 3D DWI image comprising a plurality of 2D DWI scans, which has been segmented based on the intensity of the pixels in the scan to identify hyperintense regions of a brain which are candidates to correspond to infarct tissue, is processed to eliminate identified regions for which this identification was incorrect. This is done by one or more of: eliminating identified regions which are determined to be similar to the region of the scan which corresponds to the identified region reflected in the mid-sagittal plane (MSP) of the brain; and eliminating regions which are determined not to have corresponding identified regions in one or more of the other scans.

The proposed algorithm may make it possible to discriminate between infarcts and artifacts in DWI scans, and thereby reduce errors in morphological measurements.

The criterion for evaluating the similarity of symmetrically-related hyperintense regions may employ a numerical parameter which is related to the Poisson error in the intensity of each pixel. This is because the expected error in the intensity of each pixel relative to a perfect measurement of the intensity (the “intensity space” of the pixel) is typically given by a normal distribution independently of the nature of the experiment.

Two applications of the present technique are: determination that there is insufficient evidence that a given 2D scan exhibits an infarct (e.g. if, following one or both of the elimination processes proposed above, and in particular the step of eliminating symmetric regions, the amount of the remaining infarct regions does not meet a threshold); and, in an 2D scan which does exhibit an infarct, removing regions which are erroneously identified as infarcts.

The algorithm has the potential to remove artifacts from any infarct processing system. In particular, this approach has application to investigations of thrombolysis using DWT scans, and to quantify morphological properties of a newly discovered infarct. Once the algorithm above has been used to produce a post-processed image, that image may be used to quantify (i) the diffusion perfusion mismatch and (ii) size of infarct to that of MCA ratio.

Note that apart from DWI, other data acquisition techniques such as FLAIR (fluid attenuation inversion recovery), T2, ADC (apparent diffusion coefficient) are used for infarct staging. It is presently considered that the present techniques are of most interest in quantifying newly-identified infarcts, and for these DWI is most valuable, but the technique is applicable wherever the “signal of interest” or “detection of a disease” is brighter than the rest of the image. So irrespective of the type of images this technique is applicable is applicable.

The present algorithm may be implemented by a computer system. If so, it is typically performed automatically (which is here used to mean that, although human interaction may initiate the algorithm, human interaction is not required while the algorithm is carried out). The algorithm might alternatively be performed semi-automatically (in which case there is human interaction with the computer during the processing).

A specific expression of the invention is a method of processing an MRI image of a brain, the MRI image comprising a plurality of 2D MRI scans corresponding to respective planes of the brain, the method including identifying in each scan one or more hyperintense regions which are candidates to correspond to infarct tissue in the brain;
the method further comprising one or both of:
(a) eliminating identified regions in a brain hemisphere identified as containing an infarct which are determined to meet a first similarity criterion with respect to a corresponding region of the same scan located in a reflected position about a mid-sagittal plane (MSP) of the scan; and
(b) eliminating identified regions which are determined not to correspond to any said identified region in the corresponding location of the other said scans.

### BRIEF DESCRIPTION OF THE DRAWINGS

Embodiments of the invention will now be described, for the sake of example only, with reference to the following drawings, in which:

FIG. 1 is a flowchart illustrating steps of first process which is an embodiment of the invention, for eliminating pixels and regions which are symmetrically related about the MSP;

FIG. 2 is composed of FIG. 2(a) and (b) which respectively illustrate (a) similar pixels and (b) similar multi-pixel regions in infarct (I) and non-infarct (N) hemispheres;

FIG. 3 is a histogram of pixel intensities a typical DWI MRI image of a brain;

FIG. 4 is a flowchart illustrating sub-steps of first process which is an embodiment of the invention, for eliminating regions which do not have 3D spatial correlation;

FIG. 5 illustrates a structuring element used in the method of FIG. 4;

FIG. 6 shows schematically six MRI scans representing consecutive slices of a brain, and colored to illustrate infarct tissue (pale) and normal tissue (shaded);

FIG. 7 is a flowchart of a first application employing the process of FIG. 1;

FIG. 8 is composed of FIGS. 8(a) to 8(e) which show the results of carrying out the steps of FIG. 7 for a scan which is incorrectly believed to contain infract material;

FIG. 9 is composed of FIGS. 9(a) to 9(e) which show the results of carrying out the steps of FIG. 7 for a scan which is correctly believed to contain infract material;

FIG. 10 is a flowchart of a second application employing the processes of FIGS. 1 and 7;

FIG. 11 is composed of FIGS. 11(a) to 11(e) which show the results of carrying out the steps of FIG. 10;

FIG. 12 illustrates experimental data comparing the application of FIG. 7 to a known slice identification technique [13];

FIG. 13, which is composed of FIGS. 13(a) and 13(b) illustrates the effect of varying λ₁ and μ₂ on sensitivity and specificity in the application of FIG. 7;

FIG. 14 illustrates experimental data comparing the application of FIG. 10 to a known infarct segmentation technique [14];

FIG. 15 illustrates the results of processing three input MRI scans (the column of three scans in FIG. 15(a)) first by a process as shown in FIG. 1, and then by a process as shown in FIG. 7;

FIG. 16 is an example, showing the image obtained by a variation of the process of FIG. 1, using FWHM of the background peak as error on each pixel; and

FIG. 17 illustrates bright regions near the cortical surface boundary and CSF.

### DETAILED DESCRIPTION OF THE EMBODIMENT

Two processes which are embodiments of the invention will now be described. After this, we will discuss two applications which employ one or both of the processes as part of more complex algorithms, which are also embodiments of the invention. Finally we discuss experimental results of the these two applications.

### 1.1 First Process: Elimination of Symmetric Artifacts

The input to the first process is a 2D DWI scan (or a plurality of such slices, such as a plurality of axial scans of slices at respective heights in a patient's brain).

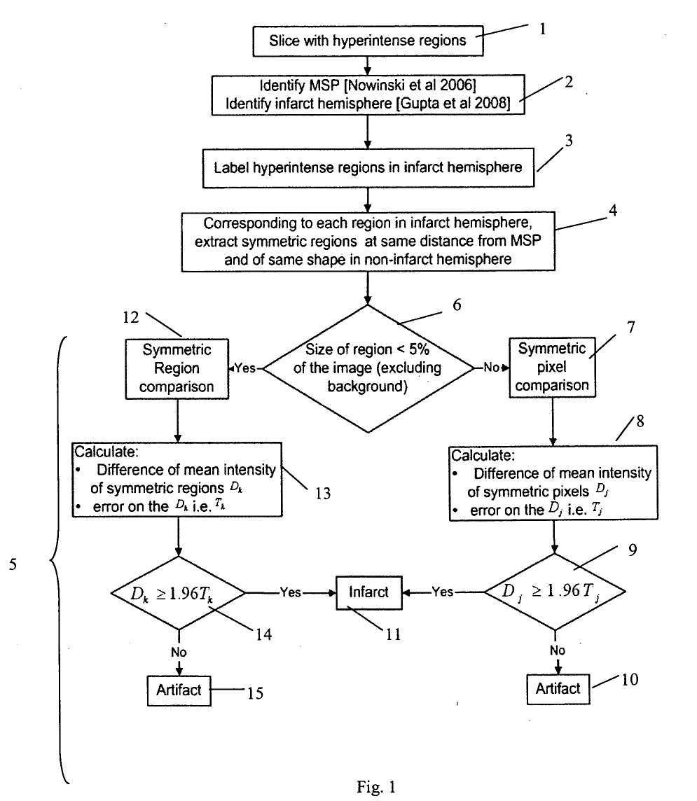

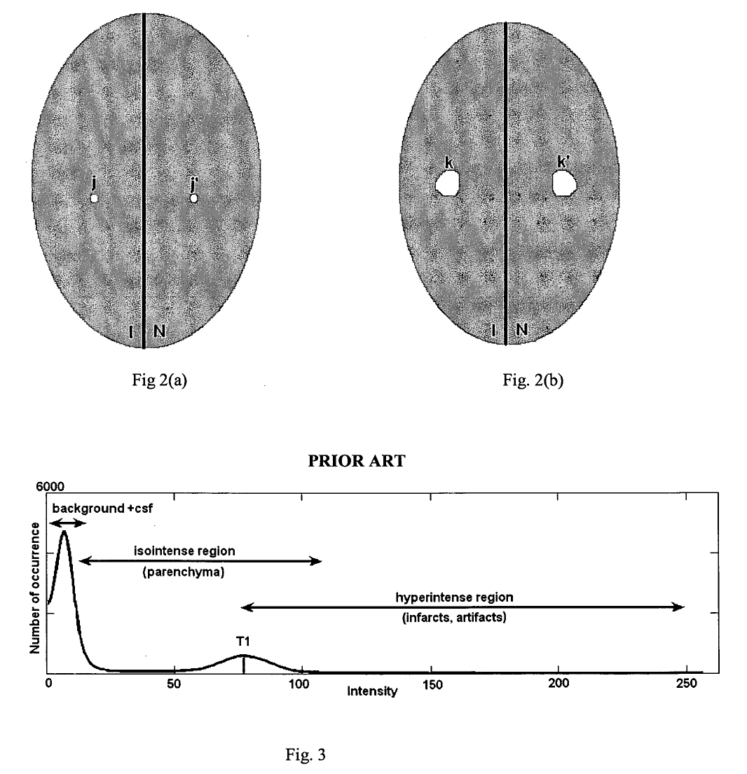

The flowchart of the first process (symmetric artifact removal) is presented in FIG. 1. This shows how the first process is used on a single 2D scan, but the process is typically performed separately for each of a plurality of such scans. The symmetric regions in question are regions of the same shape and size at the same perpendicular distance from MSP. This is illustrated in FIG. 2(a) and (b), which illustrate respectively how single pixels and multi-pixel regions may be symmetrically distributed about the MSP, in infarct (I) and non-infarct (N) hemispheres.

The input 2D DWI scan is labeled in FIG. 1 as 1. In a first step 2 of the first process, the MSP of the 2D DWI image 1 is identified, e.g. using a method disclosed by Nowinski et al (2006) [17]. The MSP divides the image into two hemispheres, each side being a close approximation to the mirror image of the other. Then the hemisphere which contains the infarct is identified, e.g. using a method disclosed by Gupta et al (2008) [14].

In a second step 3, the hyperintense regions in the infarct hemisphere are labeled. This can be done by obtaining an intensity histogram of the infarct hemisphere. As is known from the prior art, a typical intensity histogram of an MRI image containing infarct material is as shown in FIG. 1, and includes two peaks. The peak at higher intensity is defined as T1, and is the approximate boundary between the hyperintense and isointense normal tissue regions. Pixels which have intensities equal to or greater than T1 are identified as hyperintense. That is, the image is segmented, with each pixel being labeled as hyperintense or not. These pixels may be isolated (i.e. single pixel regions), or may be part of multi-pixel regions. In either case, the regions are labeled as hyperintense regions. The regions are generated by applying a segmentation algorithm such as [15]. The size of the region are calculated using the total number of pixels in the segmented regions.

In step 4, for each hyperintense region in the infarct hemisphere, a corresponding mirror region (at the same distance from the MSP and of the same shape) in the non-infarct hemisphere is examined. The size of region is calculated.

The set of steps indicated as 5 in FIG. 1 is then performed for each of the segmented hyperintense regions of the infarct hemisphere.

First, in step 6, it is determined if the size of segmented region of the infract hemisphere is less than 5% of the total image size (excluding the background).

If the result of the determination of step 6 is “no”, then the situation is as in FIG. 2(b). The method then initiates (step 7) a process of comparing the two symmetrically related regions. This is done by carrying out the set of steps 8 to 11 once for each pixel of the region. In each set of steps, we refer to the two symmetric pixels as j (say in the infarct hemisphere) and j′ (say in the non-infarct hemisphere), and their intensities are denoted pⱼ and p_{j′} respectively. The error on both the pixels (by assuming that the intensities of each pixel obey a Poisson distribution) is therefore \sqrt{pⱼ} and \sqrt{p_{j′}} respectively.

Let Dⱼ=pⱼ−p_{j′} be the difference of intensities of pixels j and j′. From the Law of propagation of errors, [18], the total error on the difference of intensity is obtained (step 8) as:

$$\begin{matrix}{T}_{j} = \sqrt{{( \frac{\partial {D}_{j}}{\partial {p}_{j}} δ {p}_{j} )}^{2} + {( \frac{\partial {D}_{j}}{\partial {p}_{{j}^{′}}} δ {p}_{{j}^{′}} )}^{2}} \\ = \sqrt{{( 1 * \sqrt{{p}_{j}} )}^{2} + {( - 1 * \sqrt{{p}_{{j}^{′}}} )}^{2}} \\ = \sqrt{{p}_{j} + {p}_{{j}^{′}}}\end{matrix}$$

where

$$\frac{\partial {D}_{j}}{\partial {p}_{j}} , \frac{\partial {D}_{j}}{\partial {p}_{{j}^{′}}}$$

are partial derivatives and δpⱼ(=\sqrt{pⱼ}), δp_{j′}, (=\sqrt{p_{j′}}) are errors on intensity of pixels j and j′.

We use this error to estimate the 95% confidence interval around the difference of intensities equal to 0. The pixels (j and j′) are considered to have similar intensities (i.e. there is no evidence that the intensity of one is due to an infarct), if it is determined (step 10) that the difference of their intensities lies in the 95% confidence region around zero i.e. Dⱼ≦1.96Tⱼ (http://mathworld.wolfram.com/ConfidenceInterval.html, accessed Oct. 23, 2007). More generally, the similarity criterion for regarding two pixels as having similar intensities can be written as Dⱼ≦λ₁Tⱼ, where λ₁ is a similarity parameter. Below we investigate the effects of varying λ₁, which is equivalent to exploring other confidence intervals.

Alternatively, if the result of the determination of step 6 is “yes”, then the situation is as in FIG. 2(a). In this case, the process initiates a comparison of the two symmetrically-related regions (step 12). Assume there are n pixels in any arbitrary region k and the mean intensity Rₖ of the region is:

$${R}_{k} = \frac{1}{n} {\sum }_{j = 1}^{n} {p}_{j}$$

The error Eₖ in Rₖ is derived from the Law of propagation of errors [18] as:

$$\begin{matrix}{E}_{k} = \sqrt{{\sum }_{j = 1}^{n} {( \frac{\partial {R}_{k}}{\partial {p}_{j}} δ {p}_{j} )}^{2}} \\ = \sqrt{{\sum }_{j = 1}^{n} {( \frac{1}{n} \sqrt{{p}_{j}} )}^{2}} \\ = \frac{1}{n} \sqrt{{\sum }_{j = 1}^{n} {( \sqrt{{p}_{j}} )}^{2}} \\ = \frac{1}{n} \sqrt{{\sum }_{j = 1}^{n} {p}_{j}} ,\end{matrix}$$

where

$$\frac{\partial {R}_{k}}{\partial {p}_{j}}$$

is the partial derivative of Rₖ with respect to pⱼ and δpⱼ is the error on the intensity of j^{th} pixel.

The difference of mean intensities of two regions is calculated (step 13) as:

Dₖ=Rₖ−R_{k′}.

The total error in the difference of mean intensities of regions is calculated as:

$$\begin{matrix}{T}_{k} = \sqrt{{( \frac{\partial {D}_{k}}{\partial {R}_{k}} δ {R}_{k} )}^{2} + {( \frac{\partial {D}_{k}}{\partial {R}_{{k}^{′}}} δ {R}_{{k}^{′}} )}^{2}} \\ = \sqrt{{( 1 * {E}_{k} )}^{2} + {( - 1 * {E}_{{k}^{′}} )}^{2}} \\ = \sqrt{{E}_{k}^{2} + {E}_{{k}^{′}}^{2}}\end{matrix}$$

Here, δRₖ and δRₖ, are errors on Rₖ and R_{k′} which are defined as Eₖ and E_{k′}. Any two regions k and k′ are considered to have similar intensities if it is determined (step 14) that Dₖ≦1.96Tₖ. Similar regions are symmetric regions with similar intensities. More generally, the similarity criterion can be varied, such that it is expressed as Dₖ≦λ₁Tₖ where λ₁ is again the similarity parameter, to explore other confidence intervals.

The symmetric regions and symmetric pixels with similar intensities are considered as artifacts. Specifically, if the determination in steps 9 and 14 is negative, the pixel in the infarct hemisphere is excluded from the set of identified infarct pixels (steps 10 and 15 respectively). Otherwise, it is confirmed that the pixel is indeed an infarct pixel.

### 1.2. Second Process: Elimination of Regions not Exhibiting 3-D Spatial Coherence

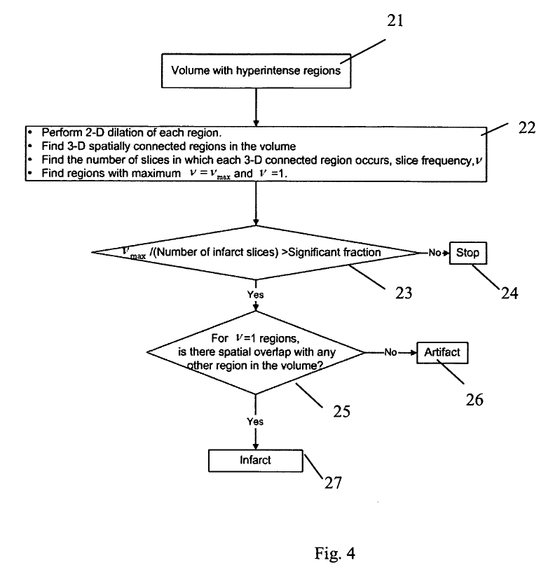

The flowchart diagram of different steps of determining 3-D spatial coherence is given in FIG. 4. The input to the method is a 3D MRI image (typically, a plurality of 2D MRI scans in parallel, spaced-apart planes) 21.

In step 22 we perform the following set of image processing sub-steps.

First, image dilation [19-20] is performed using a structuring element obtained by taking into account the spatial error around each pixel [http://www.cis.rit.edu/htbooks/mri/, http://www.sunnybrook.ca/research/groups/cardiac_mri/MR_background]. The surrounding region around each pixel can be regarded as the spatial error region.

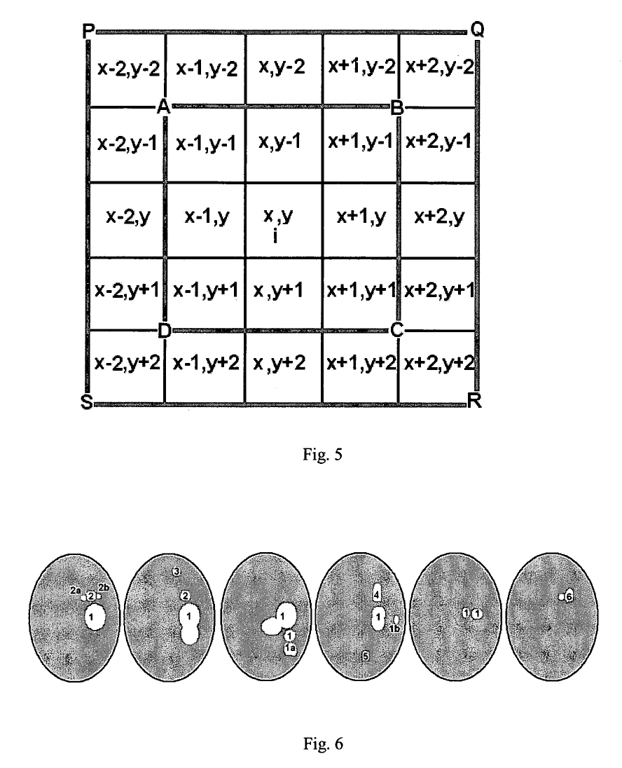

The structuring element is illustrated in FIG. 5. The i^{th} pixel is the central pixel of the diagram, with co-ordinates (x, y). The minimum error region around the i^{th} pixel is identified as 1 pixel-wide band surrounding the i^{th} pixel in all directions which is the 3×3 pixel square ABCD in FIG. 5. We call square ABCD the 1 pixel relationship square. Similarly, square PQRS in FIG. 5 is a 2 pixel relationship square. In our investigations, the size of the spatial error square was varied from 3×3 pixels to 11×11 pixels. No dilation corresponds to maximum artifact removal (but can has a higher risk of removal of infarct regions) while dilation with 11×11 pixels connects the entire image which makes all the regions spatially coherent. So, in our experimental results we used a structuring element for dilation which was a middle value spatial error square of 7×7 pixels (i.e. the i-th pixel is surrounded by 3 pixels in each direction, which is a structuring element larger than the one shown in FIG. 5).

Second, we determine 3-D connected regions in the volume [21]. Note that in each region, the dilated regions have a slightly different shape. The criterion for deciding that regions in consecutive scans are connected is that at least one pixel must be in common between the hyperintense regions of the consecutive scans.

Third, we calculate the number of slices in which a 3-D connected region occurs continuously, which is called slice frequency ν. For example in FIG. 6, which shows a series of consecutive 2D scans, region 1 has ν=5 as it occurs in 5 consecutive slices. Region 2 has ν=2 and regions 3, 4, 5 and 6 have ν=1.

Fourth, we determine the maximum ν which is denoted ν.

In step 23 we determine whether νₘₐₓ/total infarct slices is a greater than a parameter indicating a significant fraction of the total number of slices. For example, for cases in which the number of interfarct slices is greater than one, we may take the significant fraction as 0.9. If this determination is negative, the process stops (step 24).

Otherwise, in step 25 find any regions with ν equal to 1. Note that a region may have ν equal to 1 even if a similar region appears at the same location (in the 2D space of the scans) after a gap of one of more slices (e.g. regions 2, 4 and 6 in FIG. 6). So for each region with ν equal to 1 a search is made to find corresponding regions in other slices. The regions with no counterpart are regarded as isolated regions which are identified as artifacts (step 26) and eliminated from the set of identified infarct regions. Conversely, regions for which ν equal to 1 but there are counterpart regions (irrespective of how far apart the two scans are which have counterpart regions) and also regions for which ν is greater than 1, are confirmed as being infarct regions (step 27).

### 2.1 First Application: False Positive Slice Reduction

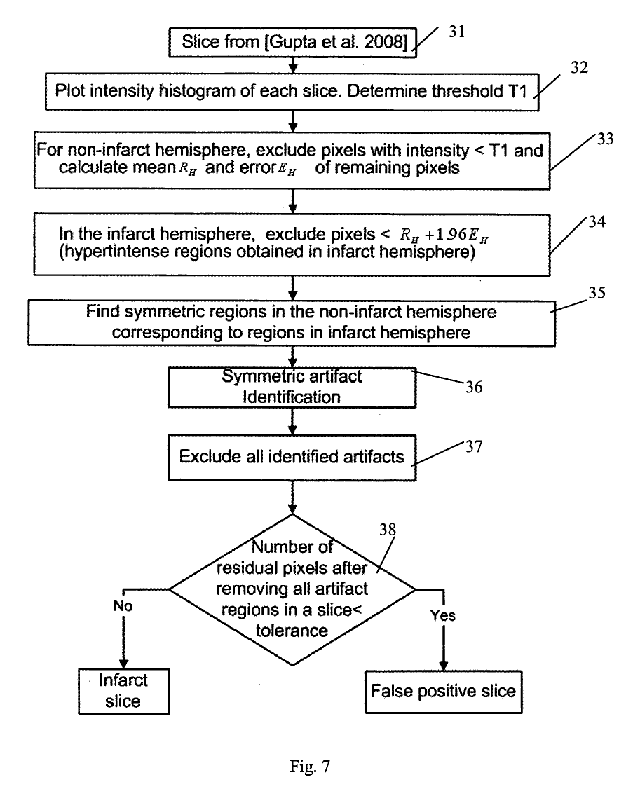

The first application of the processes above (especially the first process) is for identification of slices for which in fact there is insufficient evidence that infarct material is present. A flowchart to show the application is displayed in FIG. 7 and the details are presented below. Note that there is some overlap between the flow diagram of FIG. 7 and that of FIG. 1 as explained below.

The input to the application is a set of slices which have been identified as likely to contain infarct material, for example by an existing automatic slice identification algorithm [14] which also obtains the hemisphere in which the infarct is likely to be. This existing algorithm can be regarded as a first step 31 of the application, and corresponds to part of step 2 of FIG. 1.

In step 32 the hyperintense regions in infarcted hemisphere are obtained by excluding the pixels below a threshold value, say ψ. The value of ψ is obtained as follows. As mentioned above, the second peak in the intensity distribution of a DWI scan (e.g. FIG. 1) represents the normal tissue region (or isointense region). If we approximate the normal tissue intensity distribution to Gaussian distribution [1], the intensity at the peak maximum (T1) represents the approximate boundary of the hyperintense and isointense normal tissue region. We then ignore that pixels with a threshold less than (T1), and determine mean (R_{H}), and the total error on the mean (E_{H}), of intensity of the remaining non-infarct hemisphere pixels.

We now set ψ=R_{H}+λ₂E_{H} where λ₂ is a second similarity parameter, and exclude all pixels with a lower intensity (step 34). Steps 33 and 34 correspond to step 3 of FIG. 1. For the experimental results presented below, we used λ₂=1.96 (corresponding to 95% confidence interval about the difference of zero). However, below we also explore other confidence intervals by varying λ₂ to explore the effect on results.

We now perform symmetric region identification (step 35, corresponding to step 4 of FIG. 1), identification of symmetric artifacts (step 36, corresponding to steps 7-9 and 12-14 in FIG. 1) and exclusion of the symmetric pixels (step 37, corresponding to steps 10 and 15 in FIG. 1).

In step 38, we determine the number of infract pixels remaining in the slice after the exclusion, and whether this number of residual pixels is above or below a tolerance parameter. If the number is below the tolerance parameter, the slice is a false positive slice. If the number is above the tolerance parameter, the slice is confirmed as being an infarct slice.

In our experiments, we have taken the tolerance parameter as 0.01% of the total number of pixels in the image after excluding the background.

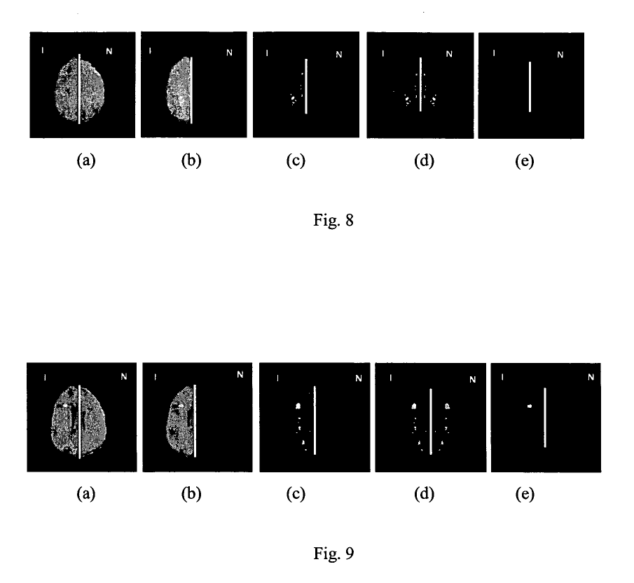

FIG. 8 shows the results of applying the first application to a false positive slice. The infarct hemisphere is represented by I and the non-infarct hemisphere by N. FIG. 8(a) shows the false positive slice which is input to the method and after the identification of the MSP. FIG. 8(b) shows the infarct hemisphere. FIG. 8(c) shows the infarct hemisphere after removal of isointense regions (i.e. after step 34). FIG. 8(d) shows the image after the corresponding regions in non-infarct hemisphere N have been added. FIG. 8(e) shows the image after removal of regions with Dₖ≦1.96Tₖ. It will be seen that this is almost totally dark, so that the number of bright regions is not equal to the tolerance parameter, and the scan is identified as a false positive.

FIG. 9 illustrates corresponding results from a slice containing infarct material. Again, the infarct hemisphere is represented by I and the non-infarct hemisphere by N. FIG. 9(a) shows the input infarct slice. FIG. 9(b) shows the infarct hemisphere. FIG. 9(c) shows the infarct hemisphere after removal of the isointense region. FIG. 9(d) shows the image after the re-introduction of the corresponding regions in non-infarct hemisphere. FIG. 9(e) shows the image after removal of similar intensity regions. It will be seen that there are several bright regions, in fact a number of bright pixels above the tolerance parameter, and the scan is confirmed as a true infarct scan.

### 2.2. Second Application: Artifact Reduction in Infarct Slices

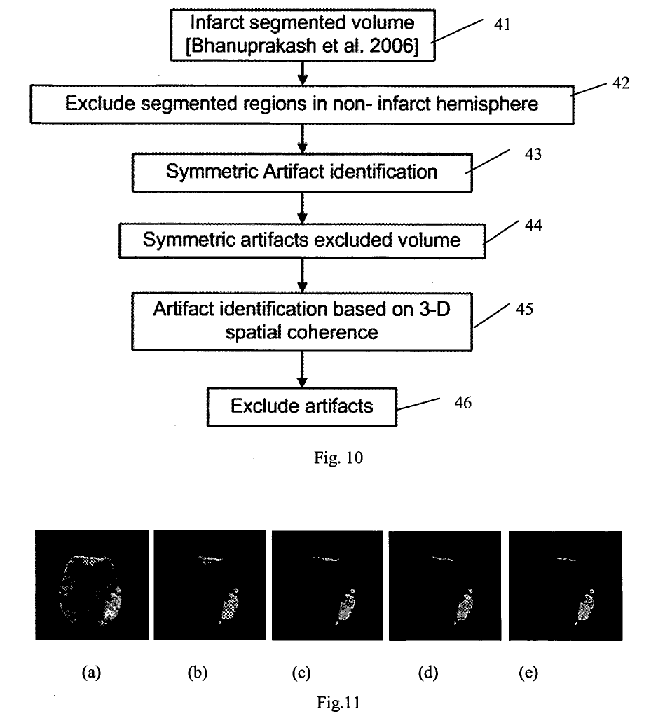

The second application is illustrated in FIG. 10. This application employs the first process (FIG. 1) and second process (FIG. 7), so there is some overlap between FIGS. 1, 7 and 10.

A first step 41 of the algorithm of FIG. 10 is sub-steps to identify the hyperintense regions, which are then taken as candidate infract regions. Step 41 can be carried out by a known algorithm for automatic infarct segmentation from DWI volume data [15].

The next step 42 of the algorithm is to obtain the hemisphere which contains the infarct (this can be done, for example, by the method disclosed in [14]), and exclude all the hyperintense segmented regions in the other (“non-infarct”) hemisphere. That is, any regions of the non-infarct hemisphere which had previously been considered be candidate infarct regions, are relabeled such that they no longer are. This corresponds broadly to steps 2-3 of FIG. 1.

The algorithm next (step 43) identifies symmetric artifacts and (step 44) excludes them. This corresponds to steps 4 and 5 of FIG. 1.

The algorithm next (step 45) identifies further artifacts based on 3-D spatial coherence (i.e. the process of FIG. 4), and (step 46) removes those artifacts. This is the second process which is described in FIG. 7.

The steps of artifact removal are displayed in FIG. 11. FIG. 11(a) shows the original slice. FIG. 11(b) shows the segmented slice. FIG. 11(c) shows the image after the artifacts in the non-infarct hemisphere are removed. FIG. 11(d) shows the result of symmetric artifact removal. FIG. 11(e) shows the result of removing the spatially incoherent regions.

### 3.1. Materials

We now present experimental results using the processes and applications described above. Fifty one DWI scans were used in this study. This is data the we had used before.

(i) To test automatic slice identification (i.e. the application of FIG. 7 we used 36 data set used by [14]. The DWI scans had in-plane resolutions of 0.9 mm×0.9 mm to 2.4 mm×2.4 mm, slice thickness of 4-14 mm, and number of slices from 4 to 36.
(ii) To test automatic infarct segmentation (i.e. the application of FIG. 10 we used 13 DWI cases used by [15]. The DWI scans had in-plane resolutions of 1 mm×1 mm or 1.5 mm×1.5 mm, and 5 mm slice thickness. The number of slices in DWI scans was from 27 to 33. The matrix size of DWI scans was 256×256. Note that the 13 DWI cases are a subset of 36 dataset used in [14].
(iii) 15 additional data set were used to demonstrate application of the proposed algorithm to improve results of a third algorithm [16]. The DWI scans had in-plane resolutions of 1.17 mm×1.17 mm to 2.42 mm×2.42 mm, slice thickness of 6.5-7 mm, and number of slices from 15-20.

Ground truth for all the data sets was marked by an expert.

### 3.2. False Positive Slice Reduction

The automatic Slice and Hemisphere identification algorithm [14] was aimed at automatically identifying the infarct slices and infarct hemisphere. The results of automatic detection of slice identification [14] were: Sensitivity=0.981, specificity=0.514, DSI [22]=0.665. After processing the data with the current technique (that is, the process of FIG. 7) the results are: sensitivity=0.9659, specificity=0.6660, DSI=0.7338.

Out of 36 cases, 26 cases showed an improvement in results due to false positive slice removal. The results of remaining 10 cases were unaffected by the processing. If we consider only those cases in which the results changed, the change in results is as follows: initial results for 26 data: (sensitivity, specificity, DSI)=(0.982, 0.474, 0.586). After processing the results for 26 data: (sensitivity, specificity, DSI)=(0.958, 0.664, 0.677). Thus, an increase in specificity and DSI is observed by 19% and 9.1%, respectively, with a decrease in sensitivity by 2.4%. The false negative slices which were removed had an insignificant fraction of area as compared to the maximum area of infarct in a slice. By using the proposed algorithm we are able to remove 31% of the false positive results.

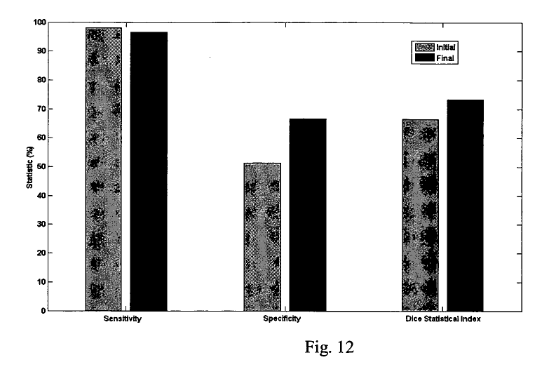

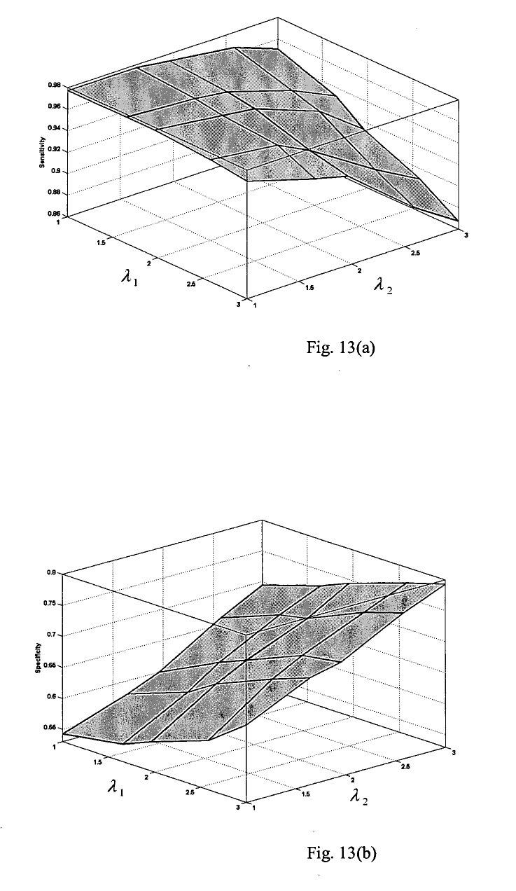

FIG. 12 displays the overall change in sensitivity, specificity and DSI as a result of the current algorithm. The left (light grey) bar of the histogram indicates the results obtained in [14], while the corresponding right (darker) bars shown the results of the algorithm of FIG. 7.

FIG. 13(a) shows the effect of changing λ₁ and λ₂(which, as described above, are employed in the criteria Dₖ≦λ₁Tₖ and R_{H}+λ₂E_{H}, respectively) on the sensitivity of infarct slice identification, and FIG. 13(b) shows the effect on the specificity of infarct slice identification. The vertical axes show sensitivity and specificity respectively. The sensitivity remains more or less unchanged for values of λ₁ and λ₂ less than 2. For λ₁ and λ₂ greater than 2, sensitivity starts decreasing steeply (since even the infarct region starts getting eliminated) and attains the value of 86.7% at λ₁ and λ₂ equal to 3. The specificity increases continuously with increase in value of λ₁ and λ₂ to 3 (=79.3%). Since high sensitivity is important, we have used values of both the parameters as 1.96 where the (sensitivity, specificity) are (96.6%, 66.6%).

The overall increase in (specificity, DSI) is (15.2%, 6.9%) with decrease in the sensitivity by only 1.5%.

### 3.3 Artifact Reduction

The results of infarct segmentation algorithm in [15] were as follows: sensitivity=0.81, specificity=0.99 and DSI=0.60. After processing the data with proposed algorithm (i.e. the application of FIG. 10), the results are: sensitivity=0.793, specificity=0.993, and DSI=0.676.

Out of 13 volumes, all the cases showed an improvement in results due to artifact removal. Only 6 cases had DSI<0.5 out of the total of 13 cases. The average DSI for these 6 cases before processing with current algorithm was 18.3%. After processing with the proposed algorithm, the average increase of DSI is 11.2%. The seven cases which had an average DSI of 74.7% after post processing increased by 4.7%. Thus effect of current processing is more significant in cases where there are a large number of artifacts. The fraction of false positive pixels removed by the current algorithm is 71%.

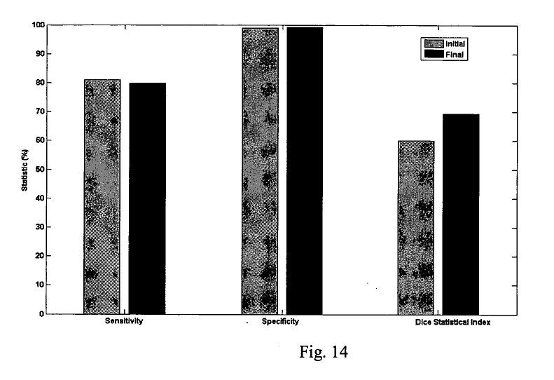

FIG. 14 displays the overall change in sensitivity, specificity and DSI as a result of the current algorithm. The left (light grey) bar of the histogram indicates the results obtained in [15], while the corresponding right (darker) bars shown the results of the algorithm of FIG. 10.

Since the number of true negative pixels is of the order of total slice pixels and is much larger than the false positive pixels, specificity is always very large. It is hardly affected by any change in the number of false positive pixels. That is why no change in specificity is observed in FIG. 14. Therefore, DSI is a better measure to study in this case as it is independent of true negative pixels. The overall improvement in DSI is 7.6%.

In [16] we segmented 15 data (5 each of low, medium and high artifact density). In another test of the application of FIG. 10, the results from [16] were then processed using the application of FIG. 10. The average change in (sensitivity, specificity, DSI) was from (74.02, 99.69, 67.32) % to (72.27, 99.87, 72.4) %. The DSI showed an improvement of 5.1%.

### 4.1 Discussion

One of the goals of stroke CAD is to accurately and automatically identify, segment and measure the stroke region. This is important (a) in context of thrombolysis which requires quantifying the diffusion perfusion mismatch and size of infarct to that of MCA ratio (b) to provide input parameters for studies involving prognostic information like quantifying the impact of infarct location on stroke severity [23], quantification of patterns of DWI lesions [24] etc. While the state-of-the-art algorithms are being developed for achieving the final goal of stroke CAD, the presently proposed algorithms have stand alone applications in related areas of research. The embodiments make it possible to discriminate infarcts and artifacts based on the following two observational properties in DWI scans. They are motivated by two observations:

(i) A first observation is that a normal DWI scan in an axial plane shows both the hemispheres to have approximately similar features in terms of intensity, shape etc [e.g. 25]. Thus, if a DWI scan shows symmetric hyperintense regions in both hemispheres, they are most probably artifacts. An infarct caused by vessel occlusion most likely occurs in a single hemisphere so it will be much more hyperintense than the symmetric region in the opposite hemisphere. The embodiments quantify significant difference of intensity using the Poisson distribution in the intensity space of each pixel.
(ii) The second observation is that the infarct regions in different slices show spatial coherence. The regions that occur at distant locations from the spatially coherent regions are most probably artifacts. The embodiments detect spatial coherence by determining the overlap of dilated regions in different slices.

In many cases even the artifacts show 3-D spatial coherence. For that reason, the embodiment of FIG. 10 processes 3-D spatial coherence after symmetric artifact removal, which reduces the chances of artifacts exhibiting 3-D spatial coherence. From our observations [15], it is very rare to find an artifact which is symmetric to an infarct. So the chances of an infarct being removed by an algorithm which employs 2-D symmetry (such as that of FIG. 1) is very low, which in turn enhances the chance of the result of the algorithm being spatially symmetric.

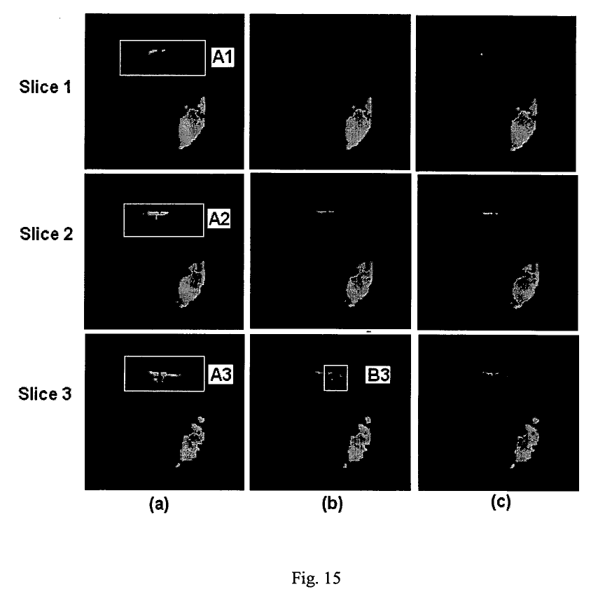

This is illustrated in FIG. 15. The column of 3 slices shown in FIG. 15(a) includes artifacts (in the boxes labeled A1, A2 and A3) which are symmetric and spatially coherent. By the process of FIG. 1, the symmetric artifacts removed in slices 1-3 to give the scans of FIG. 15(b), in which only the artifact in box B3 has survived. The artifact in box B3 is removed by evaluating the 3-D spatial coherence of that region by a process of FIG. 4, to give the result shown as the three scans of FIG. 15(c).

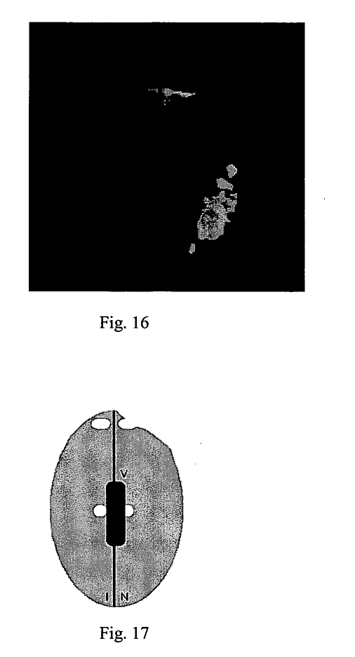

The embodiments also make use of the observation that the error in the intensity of each pixel is given by a normal distribution which is independent of the nature of the experiment and is generally associated with the randomness of the outcome of the experiment. However, since the mean and standard deviation of the normal distribution are independent, this distribution cannot be used to predict errors in the cases where it is not possible to repeat the outcome of experiment [1]. In fact, the present inventors initially considered using the FWHM of the background peak (as shown in FIG. 2) as an estimate of error on every pixel. Example results from doing so are presented in FIG. 16. However, when we compared the differences of pixel intensities, even at the level of 3 sigma confidence interval around the difference of zero, there were residuals at hyperintense pixel regions (note that, by contrast, in the FIG. 1 process, we have used 1.96 sigma confidence interval around the difference of zero). This implies that larger errors need to be assumed for brighter pixels. This increases our confidence in an assumption of Poisson errors since, by definition, errors are proportional to the intensity.

Identifying pixels which are symmetric about the MSP and have similar intensities to remove symmetric artifacts is very sensitive to errors such as: inherent asymmetry in hemispheres, the inter-hemispheric fissure being curved to a greater extent, etc. For that reason, the present embodiments by preference consider symmetric regions instead of individual pixels for the purpose of comparing the intensities. Even while considering the symmetric regions, due to inherent asymmetry of hemispheres about the MSP, regions lying close to the cortical surface boundary or too close to the ventricles or cerebrospinal fluid (CSF) may contain part of background or parenchyma. This is shown in FIG. 17, where the ventricle V which lies on the MSP has obscured a part of the bright region adjacent to it on the N hemisphere, and further asymmetry is caused by the part of the bright region at the upper right of the N hemisphere which is close to the cortical surface. However, since the embodiments exclude pixels with intensity below T1, the mean of region intensity is not affected by the hypointense pixels due to the background or the parenchyma.

Based on the quantification of small, middle and large artifacts in [14], large infarct regions are expected to be those which are above about 5% of the image (excluding the background). Such large regions might have greater errors due to inhomogeneity (e.g. caused by intra slice variation during data observation). For this reason if a region is considered as a large region, the embodiment of FIG. 1 performs pixel to pixel comparison. Pixel to pixel comparison may disintegrate large areas but does not completely remove them.

The 3-D spatial coherence is tested only in the cases where the ratio of νₘₐₓ to the total number of infarct slices is at least equal to a ratio which is considered significant. The choice of high significant ratio as 0.9 is considered to establish the confidence that the infarct occurs at the similar location in the slices (cases with number of infarct slices=1 are excluded for this analysis). This is done to avoid cases in which the infarct occurs at multiple locations and there may be a significant chance that a spatially isolated region is an infarct. In the case that an infarct occurs mainly in one region, the chances that spatially isolated regions represent artifacts are high.

One of the assumptions for this algorithm is that the artifacts are symmetric about the MSP. Infarcts that are caused by vessel occlusion are most likely to be located in one hemisphere. In some rare cases (e.g., caused by a sudden drop in blood pressure in the presence of bilateral stenosis), infarcts may be present in both the hemispheres almost symmetrically. In such cases, only the spatial coherence test of the regions is performed. Symmetry based artifact removal should not be performed then. During data acquisition, the head may be tilted such that there is a significant roll angle. In such cases, the symmetry about the midsagittal plane is violated and 2-D symmetry based comparison of hyperintense regions may be erroneous.

When an artifact is symmetric to an infarct region, there may be a chance of losing an infarct region. In addition, there are various reasons because of which artifacts may be retained by the present embodiments, including:
(i) Inhomogeneity within the slice and the volume. If so, applying intra-slice and inter slice inhomogeneity corrections [e.g. 26-27] can further help to enhance the results.
(ii) Asymmetric artifacts close to an infarct region may not get identified by any of the criteria studied in the embodiments.
(iii) Large artifacts may be only fragmented rather than completely removed as we apply pixel wise comparison of such regions. Note that, as mentioned above, pixel-wise comparison generally does not completely remove the whole region.

Nevertheless, it is clear from the experimental results that the embodiments provide a fast and pragmatic approach for artifact removal. They do not utilize anatomy related information whose processing may be challenging and more time consuming. The present approach also does not take into account the location of infarct, which is critical [23-24], and influences the outcome.

The embodiments can be applied as a stand alone post processor or be a part of a stroke CAD system, and can provide a fast post-processing tool to reduce artifacts in infarct processing applications. In fact, the processing time for the present embodiments, when implemented on a matlab platform, was under 1 second.

### REFERENCES

1. Bevington P R (1969), Data Reduction and Error Analysis for the Physical Sciences, McGraw-Hill, Inc. pp 77.
2. Jammal G, Bijaoui A (1999) Denoising and deconvolution in nuclear medicine. International conference on Image processing (3): 896-900.
3. Nowak R D (1999) Wavelet-based Rician noise removal for magnetic resonance imaging, IEEE Transactions on Image Processing, Issue 10, October 8:1408-1419.
4. Thacker N A, Pokric M and Williamson D C. (2004) “Noise filtering and testing illustrated using a multi-dimensional partial volume model of MR data” Proc. BMVC, Kingston, 909-919.
5. Lin W, Wehrli F W and Song H K (2005) Correcting bulk in-plane motion artifacts in MRI using the point spread function, MedImg, Issue 9, September, 24:1170-1176.
6. Huo Z, Giger M L, Vyborny C J, Wolverton D E, Schmidt R A, Doi K (1998) Automated computerized classification of malignant and benign mass lesions on digitized mammograms. Acad. Radiol. 5:155-168
7. Uehara M, Saita S, Kubo M, Kawata Y, Niki N, Nishitani H, Tominaga K, Moriyama N (2005) A computer aided diagnosis for osteoporosis using multi slice CT images. RSNA 816.
8. Park H, Bland P H, Meyer C R (2003) Construction of an abdominal probabilistic atlas and its application in segmentation. IEEE Trans. On Med Imaging 22:483-492.
9. Yoshida H, Näppi J, MacEneaney P, Rubin D T, Dachman A H (2002) Computer-aided diagnosis scheme for detection of polyps at CT colonography. Radiographics 22:963:979.
10. Nowinski W L, Qian G, Bhanu Prakash K N, Volkau I, A. Thirunavuukarasuu, Hu Q, A. Ananthasubramaniam, Liu J, Gupta V, Ng T T, Leong W K, Beauchamp N J (2007) A CAD system for acute ischemic stroke image processing. International Journal of Computer Assisted Radiology and Surgery, 2 (Suppl. 1):220-222.
11. Nowinski W L, Qian G, Leong W K, Liu J, Kazmierski R, Urbanik A (2007). A Stroke CAD in the ER. 93 Radiological Society of North America Scientific Assembly and Annual Meeting Program 2007, Chicago, USA, 25-30 Nov. 2007:837.
12. Nowinski W L, Qian G, Bhanu Prakash K N, Volkau I, Bilello M, Beauchamp N J: A CAD system for stroke MR and CT. 92 Radiological Society of North America Scientific Assembly and Annual Meeting Program 2006, Chicago, USA, 25 Nov.-1 Dec. 2006:789.
13. Nowinski W L, Qian G Y, Bhanu Prakash K N, Volkau I, A. Thirunavuukarasuu, Beauchamp N J, Runge V W, Ananthasubramaniam A, Liu J, Qiao Y, Hu Q, Bilello: Atlas-assisted MR stroke image interpretation by using anatomical and blood supply territories atlases. Program 91st Radiological Society of North America Scientific Assembly and Annual Meeting RSNA 2005, Chicago, Ill., USA, 27 Nov.-2 Dec. 2005:857.
14. Gupta V, Bhanu Prakash K N, Nowinski W L (2008), Automatic and rapid identification of infarct slices and hemisphere in DWI scans. Acad. Radiol, 15: 24-39.
15. Bhanu Prakash K N, Gupta V, Bilello M, Beauchamp N J, Nowinski W L (2006). Identification, segmentation and image property study of acute infarcts in diffusion-weighted images by using a probabilistic neural network and adaptive gaussian mixture model. Acad. Radiol 13:1474-1484.
16. Bhanu Prakash K N, Gupta V, Nowinski W L (2006): Segmenting infarct in diffusion weighted imaging volumes. Patent application PCT/SG2006/000292, filed 3 Oct. 2006.
17. Nowinski W L, Bhanu Prakash K N, Volkau I, Ananthasubramaniam A, Beauchamp N J (2006). Rapid and automatic calculation of the MSP in magnetic resonance diffusion and perfusion images. Academic Radiology; 13(5): 652-663.
18. Mandel J (1984). The Statistical analysis of experimental data, Courier Dover Publications, page 72.
19. Haralick R M, and Shapiro L G (1992). Computer and Robot Vision, Vol. I, Addison-Wesley, pp. 158-205.
20. Boomgaard van den and Balen van (1992) Image transforms using bitmapped binary images. Computer Vision, Graphics and Image Processing: Graphical Models and Image Processing No. 3, May, 54:254-258.
21. Sedgewick R. Algorithms in C, 3rd Ed., Addison-Wesley, 1998, pp. 11-20.
22. Zou K H, Warfield S K, Bharatha A, Tempany C M C, Kaus M, Haker S, Wells WM III, Jolesz F A, Kikinis R. (2004) Statistical validation of image segmentation quality based on spatial overlap index. Acad. Radiol 11:178-189.
23. Menezes M N, Ay H, Zhu M W, Lopez C J, Singhal A B, Karonen J O, Aronen H J, Liu Y, Nuutinen J, Koroshetz W J, Sorensen AG (2007). The Real Estate Factor: Quantifying the Impact of Infarct Location on Stroke Severity. Stroke 38:194-197.
24. Bang O Y, Lee P H, Heo K G, Joo U S, Yoon S R, Kim S Y (2005). Specific DWI lesion pattern predict progosis after acute ischaemic stroke within MCA territory. J. Neurol Neurosurg Psychiatry 76:1222-1228.
25. Toga A W, Thompson P M. Mapping brain asymmetry. Nature Reviews Neuroscience 2003; 4(1):37-48.
26. Chen D, Li L, Yoon D, Lee J H, Liang Z (2001) Renormalization method for inhomogeneity correction of MR images: Proc. SPIE, Med. Imaging: Image Processing, Milan Sonka; Kenneth M. Hanson; Eds Vol. 4322, p. 939-942.
27. Bammer R, Markl M, Barnett A, Acar B, Alley M T, Pelc N J, Glover G H, Moseley M E (2003) Analysis and generalized correction of the effect of spatial gradient field distortions in diffusion-weighted imaging. Magnetic Resonance in Medicine 3, 20:560-569.

1. A method of processing an MRI image of a brain, the MRI image comprising a plurality of 2D MRI scans corresponding to respective planes of the brain, the method including identifying in each scan one or more hyperintense regions which are candidates to correspond to infarct tissue in the brain;
the method further comprising one or both of:
(a) eliminating identified regions in a brain hemisphere identified as containing an infarct which are determined to meet a first similarity criterion with respect to a corresponding region of the same scan located in a reflected position about a mid-sagittal plane (MSP) of the scan; and
(b) eliminating identified regions which are determined not to correspond to any said identified region in the corresponding location of the other said scans.

2. A method according to claim 1 which includes step (a), and in which said similarity criterion is that the identified region and the corresponding region have respective intensities which differ by less than a value which is an increasing function of the intensity of the identified region.

3. A method according to claim 2 in which the value is proportional to the intensity of the identified region.

4. A method according to claim 1 which includes step (a) and further includes:
determining whether the region occupies more than a predetermined proportion of the scan;
if the determination is positive, determining pixel-by-pixel in the identified region whether said similarity criterion is met; and
if the determination is negative, determining whether the similarity criterion is met for the identified region as a whole.

5. A method according to claim 1 including both steps (a) and (b) in that order.

6. A method according to claim 1 and including step (b) in which any identified regions are excluded which are determined not to correspond to a said identified region in the corresponding location of the neighboring scan.

7. A method according to claim 1 and including step (b), including a step of determining, for each identified region of each scan, the number of consecutive scans ν which contain an identified region in corresponding locations, and determining among the determined values ν the maximal value νₘₐₓ, and terminating step (b) if νₘₐₓ is below a threshold.

8. A method according to claim 1 and including step (b), step (b) further including dilating the identified regions using a structuring element.

9. A method according to claim 1 in which said step of identifying in each scan one or more hyperintense regions which are candidates to correspond to infarct tissue includes:
(i) excluding regions of the scan which have intensities below a first threshold;
(ii) determining the mean intensity of the remaining regions of the scan, and a measure of the error in the mean intensity; and
(iii) excluding regions of the scan have an intensity which is below a function of the mean and the error.

10. A method of screening a set of 2D MRI scans corresponding to a respective plurality of planes of a brain, the method comprising:
processing the scans by a method according to any of the preceding claims and including step (a),
determining for each scan whether the area of the remaining identified regions is a above a threshold; and
if the determination is negative excluding the scan from the set of scans.

11. A computer system arranged to perform a method according to claim 1.
